(19) United States
(12) Patent Application Publication
(10) Pub. No.: US 2016/0077748 A1
(43) Pub. Date: Mar. 17, 2016

(54) STORAGE CONTROL DEVICE

(71) Applicant: FUJITSU LIMITED, Kawasaki-shi (JP)

(72) Inventor: Tadashi Kosen, Machida (JP)

(73) Assignee: FUJITSU LIMITED, Kawasaki (JP)

(21) Appl. No.: 14/811,013

(22) Filed: Jul. 28, 2015

(30) Foreign Application Priority Data
Sep. 12, 2014 (JP) 2014-186447

(51) Int. Cl. G06F 3/06

(52) U.S. Cl. CPC G06F 3/0613; G06F 3/0685; G06F 3/065; G06F 3/0659

(57) ABSTRACT

A storage control device includes a memory device and a processor. The memory device is configured to store a transfer amount of data to be transmitted to a first storage device. The processor is configured to perform, on basis of the transfer amount, a transfer request of requesting a second storage device to perform data transfer of transmitting data to the first storage device. The processor is configured to observe a throughput of the data transfer. The processor is configured to update the transfer amount on basis of the throughput.

### CROSS-REFERENCE TO RELATED APPLICATION

This application is based upon and claims the benefit of priority from the prior Japanese Patent Application No. 2014-186447 filed on Sep. 12, 2014, the entire contents of which are incorporated herein by reference.

### FIELD

The embodiments discussed herein are related to a storage control device.

### BACKGROUND

For a storage system including a plurality of storage devices (or redundant arrays of independent disks (RAIDs)), there has been a data migration technology which migrates data from one storage device to another storage device. For example, data migration is performed by a controller module (storage control device) provided in a new storage device when replacing a storage device.

A storage device of a data migration destination transmits a command to a storage device of a data migration source and receives data, which is a target to be migrated, as a response from the storage device of the data migration source. In general, since the storage device of the data migration destination has a higher performance than that of the storage device of the data migration source, the performance of the storage device of the data migration source is a bottleneck on a throughput for data migration.

Accordingly, the storage device of the data migration destination underestimates the performance of the storage device of the data migration source so that the storage device of the data migration source is not overloaded, and limits the number of commands to a fixed value.

Related techniques are disclosed in, for example, Japanese Laid-Open Patent Publication No. 2010-113383 and Japanese Laid-Open Patent Publication No. H05-40706.

### SUMMARY

According to an aspect of the present invention, provided is a storage control device including a memory device and a processor. The memory device is configured to store a transfer amount of data to be transmitted to a first storage device. The processor is configured to perform, on basis of the transfer amount, a transfer request of requesting a second storage device to perform data transfer of transmitting data to the first storage device. The processor is configured to observe a throughput of the data transfer. The processor is configured to update the transfer amount on basis of the throughput.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a storage system according to a first embodiment;

FIG. 2 is a diagram illustrating an exemplary configuration of a storage system according to a second embodiment;

FIG. 3 is a diagram illustrating an exemplary hardware configuration of a RAID device according to the second embodiment;

FIG. 4 is a diagram illustrating an example of a sequence of data migration according to the second embodiment;

FIG. 5 is a flowchart illustrating a data migration process according to the second embodiment;

FIG. 6 is a flowchart illustrating a change process of the number of commands according to the second embodiment;

FIG. 7 is a flowchart illustrating a determination process of the maximum number of commands according to the second embodiment;

FIG. 8 is a flowchart illustrating a readjustment process according to the second embodiment;

FIG. 9 is a flowchart illustrating an error process according to the second embodiment;

FIG. 10 is a graph illustrating a relationship between a performance and the number of change times of the number of commands according to the second embodiment;

FIG. 11 is a graph illustrating a relationship between a performance and the number of change times of the number of commands according to the second embodiment; and

FIG. 12 is a graph illustrating a relationship between a performance and the number of change times of the number of commands according to the second embodiment.

### DESCRIPTION OF EMBODIMENTS

Limiting the number of commands to the fixed value by underestimating the performance of the storage device of the data migration source is inefficient and requires a time for data migration.

Hereinafter, descriptions will be made on embodiments with reference to accompanying drawings.

### First Embodiment

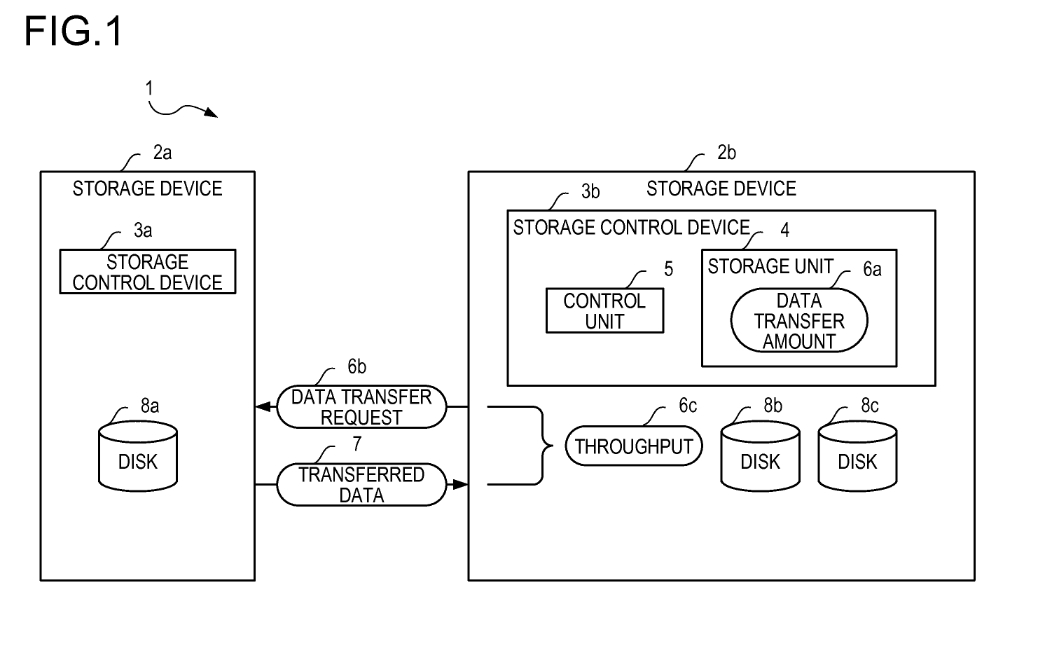

Descriptions will be made first on a storage system according to a first embodiment with reference to FIG. 1. FIG. 1 is a diagram illustrating an exemplary configuration of a storage system according to the first embodiment.

A storage system 1 includes a plurality of storage devices 2 (2a, 2b, . . . ). The storage system 1 is able to perform a data transfer from the storage device 2a to the storage device 2b, that is, the storage system 1 is capable of performing data migration.

The storage device 2a is the storage device 2 of a data migration source in the data migration. The storage device 2b is the storage device 2 of a data migration destination in the data migration. The storage device 2 includes a storage control device 3 (3a, 3b, . . . ) which controls the storage device 2 as a target and one or more disks 8 (8a, 8b, . . . ) capable of storing data. For example, the storage device 2a includes the storage control device 3a and a single disk 8a, and the storage device 2b includes the storage control device 3b and two disks 8b and 8c.

The storage control device 3b controls the storage device 2b as a target device. For example, the storage control device 3b controls a data transfer in data migration, in which data is transferred to the disk 8b or 8c of the storage device 2b, from the storage device 2b of a transfer destination. The storage control device 3b is an information processing device and is, for example, a controller module in a case where the storage device 2 is a RAID device. The storage control device 3b includes a storage unit 4 and a control unit 5.

The storage unit 4 stores a data transfer amount 6a for the storage device 2b. The data transfer amount 6a for the storage device 2b is set by the storage device 2b, which is the data migration destination in the data migration, and is a data transfer amount of data to be transferred from the storage device 2a to the storage device 2b per predetermined unit. The predetermined unit may include, for example, unit time or a cycle of a request for data transfer and a response to the request.

The control unit 5 requests data transfer appropriate to the data transfer amount 6a. The request for data transfer appropriate to the data transfer amount 6a is to request the data migration source to transmit data of which amount is capable of realizing the data transfer amount 6a, and is performed by issuing a data transfer request 6b to the storage device 2a. The data transfer request 6b is an instruction for requesting, while controlling the data transfer amount 6a, the storage device 2a to transmit data to be migrated. The data transfer request 6b may control the data transfer amount 6a by, for example, issuing a plurality of unit instructions that request predetermined data or a single instruction capable of collectively designating predetermined data.

The control unit 5 observes a throughput 6c of the data transfer. The throughput 6c is an evaluation index of a data transfer amount and is, for example, an amount of data transfer per unit time. The control unit 5 may observe the throughput 6c from transferred data 7 in response to the data transfer request 6b.

The control unit 5 updates the data transfer amount 6a on the basis of the throughput 6c. Updating of the data transfer amount 6a on the basis of the throughput 6c is to increase or decrease the data transfer amount 6a according to whether the throughput 6c is appropriate to the data transfer amount 6a. For example, the control unit 5 maintains or increases the data transfer amount 6a when the throughput 6c appropriate to the data transfer amount 6a is observed, and decreases the data transfer amount 6a when the throughput 6c appropriate to the data transfer amount 6a is not observed.

Accordingly, the control unit 5 may request the storage device 2a to transfer data appropriate to the updated data transfer amount 6a and control the data transfer amount according to the throughput 6c. Therefore, even when the data transfer amount 6a which does not have an influence on the performance of the storage device 2a is set as an initial value, the storage control device 3b may control the data transfer amount according to the throughput 6c such that an execution efficiency of the data migration may be improved.

### Second Embodiment

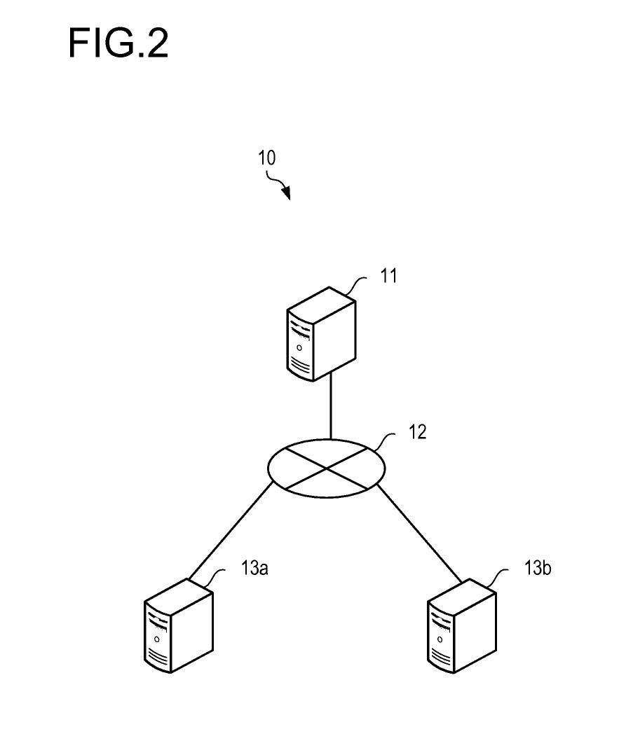

Next, a storage system according to a second embodiment will be described with reference to FIG. 2. FIG. 2 is a diagram illustrating an exemplary configuration of a storage system according to the second embodiment.

A storage system 10 includes a host 11 and RAID devices 13 (13a and 13b) connected to the host 11 through a network 12. The storage system 10 sets one of the RAID devices 13 as the RAID device 13 of the data migration source and the other of the RAID devices 13 as the RAID device 13 of the data migration destination to perform the data migration. For example, the storage system 10 sets the RAID device 13a as the data migration source and sets the RAID device 13b as the data migration destination, thereby performing the data migration.

The RAID device 13 of the data migration destination performs an execution control of the data migration. The host 11 may perform the control of the data migration in place of the RAID device 13 of the data migration destination.

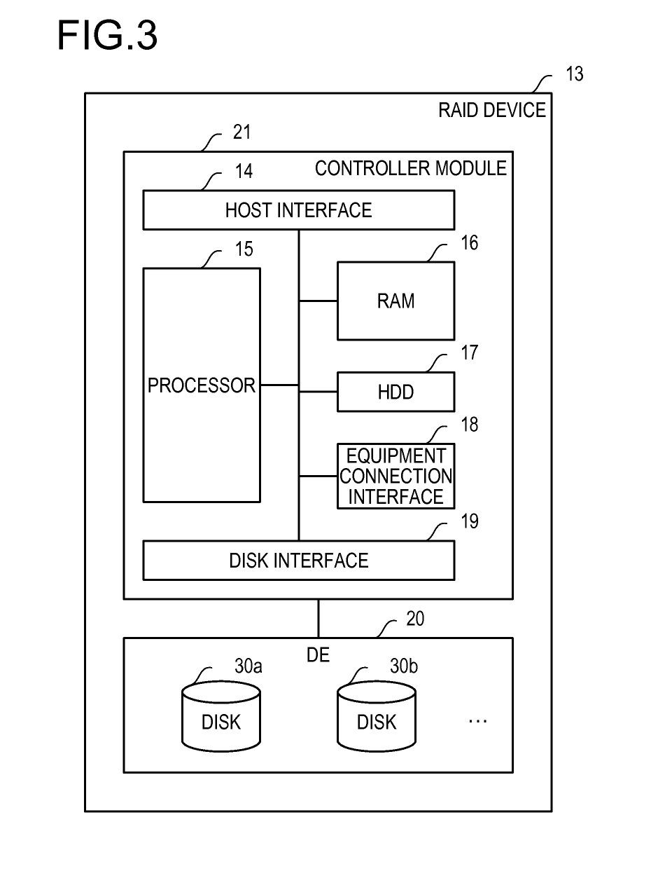

Next, a hardware configuration of the RAID device 13 will be described with reference to FIG. 3. FIG. 3 is a diagram illustrating an exemplary hardware configuration of the RAID device 13 according to the second embodiment. The RAID device 13 includes a controller module 21 and a disk enclosure (DE) 20. The RAID device 13 may include a plurality of controller modules 21 and a plurality of DEs 20.

The controller module 21 includes a host interface 14, a processor 15, a random access memory (RAM) 16, a hard disk drive (HDD) 17, an equipment connection interface 18, and a disk interface 19.

The controller module 21 is controlled in its entirety by the processor 15. The RAM 16 and a plurality of peripheral equipments are connected to the processor 15 through a bus. The processor 15 may be a multi-core processor composed of two or more processors. When there exist a plurality of controller modules 21, a master/slave relationship is established between the controller modules 21, and the processor 15 of the controller module 21 which serves as a master may control the controller module 21 which serves as a slave and the entirety of the RAID device 13.

The processor 15 is, for example, a central processing unit (CPU), a micro processing unit (MPU), a digital signal processor (DSP), an application specific integrated circuit (ASIC), or a programmable logic device (PLD).

The RAM 16 is used as a primary storage device of the controller module 21. In the RAM 16, at least a portion of an operating system (OS) program or an application program executed by the processor 15 is temporarily stored. Various data needed for a process to be performed by the processor 15 are also stored in the RAM 16. Further, the RAM 16 functions as a cache memory of the processor 15.

The peripheral equipments connected to the bus may include the host interface 14, the HDD 17, the equipment connection interface 18, and the disk interface 19. The host interface 14 transmits and receives data to and from the host 11 through the network 12.

The HDD 17 performs writing and reading data into and from a built-in disk magnetically. The HDD 17 is used as an auxiliary storage device of the RAID device 13. The OS program, the application program, and various data are stored in the HDD 17. A semiconductor storage device such as a flash memory may be used as the auxiliary storage device.

The equipment connection interface 18 is a communication interface for connecting the peripheral equipment to the controller module 21. For example, a memory device or a memory reader/writer which is not illustrated may be connected to the equipment connection interface 18. The memory device is a recording medium equipped with a function for communicating with the equipment connection interface 18. The memory reader/writer is a device which performs writing data into a memory card or reading data from the memory card. The memory card is, for example, a card type recording medium.

The equipment connection interface 18 may be connected with a display unit which is not illustrated. In this case, the equipment connection interface 18 has a function that displays information on the display unit in accordance with an instruction from the processor 15.

The equipment connection interface 18 may be connected with a keyboard or a mouse which is not illustrated. In this case, the equipment connection interface 18 transmits a signal sent from the keyboard or the mouse to the processor 15. The mouse is an example of a pointing device, and other pointing devices may be used. The other pointing devices may include, for example, a touch panel, a tablet, a touch pad, and a track ball.

The equipment connection interface 18 may be connected with an optical drive device which is not illustrated. The optical drive device reads data written into an optical disk by using, for example, laser light. The optical disk is a portable recording medium in which data is written to be capable of being read by reflection of light. The optical disk may include, for example, a digital versatile disc (DVD), a DVD-RAM, a compact disc read-only memory (CD-ROM), or a compact disc recordable/rewritable (CD-R/RW). The disk interface 19 transmits and receives data to and from the DE 20. The DE 20 is connected with the controller module 21 through the disk interface 19.

The DE 20 includes one or more disks 30 (30a, 30b, . . . ) and stores data in accordance with an instruction from the controller module 21. The disk is a storage device and includes, for example, an HDD or a solid state drive (SSD).

With the hardware configuration described above, the processing function of the RAID device 13 may be implemented. The RAID device 13 executes a program recorded in, for example, a computer-readable recording medium to implement the processing function of the RAID device 13. The program in which process contents to be performed by the RAID device 13 are described may be recorded into various recording media. For example, the program to be executed by the RAID device 13 may be stored in the HDD 17. The processor 15 loads at least a portion of the program stored in the HDD 17 onto the RAM 16 and executes the program. The program to be executed by the RAID device 13 may be recorded in the portable recording medium such as the optical disk, the memory device, or the memory card. The program stored in the portable recording medium becomes executable after being installed on the HDD 17, for example, under the control of the processor 15. The processor 15 may directly read the program from the portable recording medium to execute the program.

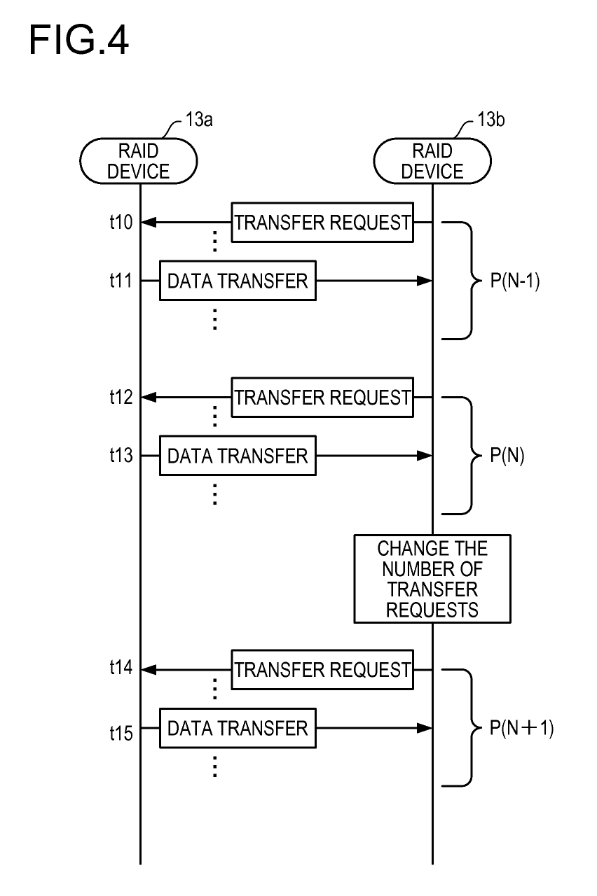

Next, descriptions will be made on a sequence of data migration according to the second embodiment with reference to FIG. 4. FIG. 4 is a diagram illustrating an example of a sequence of data migration according to the second embodiment.

Descriptions will be made on a transmission of transfer request and a data transfer when data migration is performed between the RAID device 13a and RAID device 13b. The RAID device 13a is the RAID device 13 of the data migration source, and the RAID device 13b is the RAID device 13 of the data migration destination. The RAID device 13b transmits a transfer request to the RAID device 13a to request the RAID device 13a to transfer the data. The RAID device 13b receives data from the RAID device 13a and writes the data into the disk 30. Thus, the data is migrated.

The transfer request transmitted by the RAID device 13b is an instruction (command) which requests the data transfer and is stipulated in, for example, the small computer system interface (SCSI) architecture model (SAM), the SCSI primary commands (SPC), or the SCSI block commands (SBC). The information about the command is described in, for example, a command description block (CDB). The command which requests the data transfer includes, for example, a Read command. The command may contain, for example, a logical unit number (LUN), a logical block address (LBA), and the number of blocks to be transferred regarding the data to be migrated. In a case where the command has restrictions on designating the data to be migrated and the data migration is not completed when transmitting the command once, the RAID device 13b may transmit many commands.

The RAID device 13b transmits a predetermined number of transfer requests to the RAID device 13a (timing t10). The RAID device 13a transfers the data requested from the RAID device 13b in response to the transfer request from the RAID device 13b (timing t11). When the RAID device 13b transmits a plurality of transfer requests, the RAID device 13a transfers data in response to the plurality of transmitted transfer requests.

The RAID device 13b measures a value P(N−1) of performance in a period of time spanning from timing t10 to timing t11. The P(N−1) is a value of the performance in the transmission of the (N−1)th transfer of requests. The performance is a performance value regarding a data transmission and includes, for example, throughput. The throughput includes, for example, an input output per second (IOPS), a response time, the number of I/O processing per unit time, the number of migrated data volumes per unit time.

The RAID device 13b transmits a predetermined number of transfer requests to the RAID device 13a after receiving the data with respect to the transfer request issued at timing t10 (timing t12). The RAID device 13a transfers data requested from the RAID device 13b in response to the transfer requests issued from the RAID device 13b (timing t13). The RAID device 13b measures a value P(N) of performance in a period of time spanning from timing t12 to timing t13. The P(N) is a value of the performance in the transmission of the Nth transfer of requests.

The RAID device 13b may change the number of transfer requests to be transmitted at the (N+1)th transfer of requests on the basis of the P(N). For example, RAID device 13b may change the number of transfer requests to be transmitted at the (N+1)th transfer of requests on the basis of a temporal change (a comparison result of the P(N−1) with the P(N)) of performance. When the P(N) is improved as compared to the P(N−1), the RAID device 13b may increase the number of transfer requests to be transmitted at the (N+1)th transfer of requests. When the P(N) is reduced as compared to the P(N−1), the RAID device 13b may decrease the number of transfer requests to be transmitted at the (N+1)th transfer of requests. The RAID device 13b may determine the number of transfer requests to be transmitted at the (N+1)th transfer of requests in accordance with a relative comparison result such as a rate of increase or decrease between the P(N−1) and the P(N). The RAID device 13b may determine the number of transfer requests to be transmitted at the (N+1)th transfer of requests in accordance with an absolute comparison result such as a difference between the P(N−1) and the P(N).

The RAID device 13b may change the number of transfer requests to be transmitted at the (N+1)th transfer of requests on the basis of a comparison of an expected value of a performance and the actual performance (a comparison result of a numerical value expected from the number of transfer requests with the P(N)).

The RAID device 13b transmits transfer requests of the changed number (timing t14). The RAID device 13a transfers data requested from the RAID device 13b in response to the transfer requests issued from the RAID device 13b (timing t15). The RAID device 13b measures a value P(N+1) of performance in a period of time spanning from timing t14 to timing t15. Similarly to that described above, the RAID device 13b may change the number of transfer requests to be transmitted at the (N+2)th transfer of requests on the basis of the P(N+1).

As described above, the RAID device 13 may change the number of transfer requests according to the performance in performing data migration. Accordingly, an execution efficiency of the data migration may be improved.

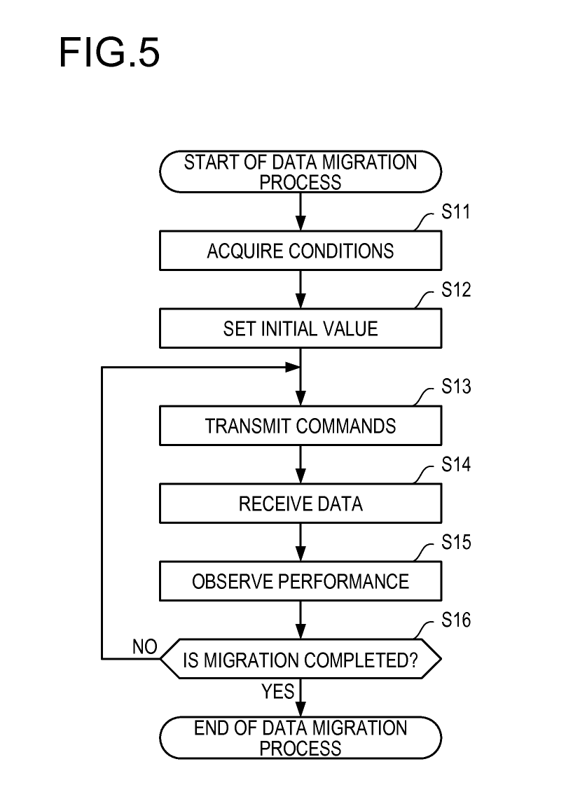

Next, descriptions will be made on a data migration process according to the second embodiment with reference to FIG. 5. FIG. 5 is a flowchart illustrating the data migration process according to the second embodiment.

The data migration process is a process in which the RAID device 13 of the data migration destination controls the migration of data from the RAID device 13 of the data migration source. In the data migration process, the maximum value of the number of commands to be issued at the time of migrating the data is obtained to perform the data migration by setting the obtained maximum value as the number of commands. Upon receiving an instruction to perform data migration, a control unit (processor 15) of the RAID device 13 of the data migration destination performs the data migration process.

The control unit acquires conditions for data migration (S11). The conditions for data migration are various pieces of information used to perform data migration. For example, the conditions for data migration are pieces of information regarding the data to be migrated and include, for example, data to be migrated, a migration source of data, a migration destination of data, a migration path, and a migration sequence. More specifically, the conditions for data migration includes, for example, information specifying the RAID device 13 in which the data to be migrated is stored, the LUN, the LBA, and an amount of data. The control unit may acquire the conditions for data migration stored in the HDD 17 or the conditions for data migration inputted by a maintenance worker.

The control unit sets an initial value of the number of commands (S12). These commands are commands to request the RAID device 13 of the data migration source to transfer data. The initial value of the number of commands corresponds to the number of the commands to be transmitted first to the RAID device 13 of the data migration source from the RAID device 13 of the data migration destination.

The control unit transmits the commands to the RAID device 13 of the data migration source (S13). For example, the control unit transmits Read commands for reading predetermined data to the RAID device 13 of the data migration source to request the data transfer. The control unit issues the Read commands, of which number is limited to a range of the initial value set at S12, at a predetermined issuance timing.

The control unit receives the data (data to be transferred) which corresponds to the transmitted commands from the RAID device 13 of the data migration source (S14). The control unit stores the received data in the disk 30 so as to migrate data to the RAID device 13 of the data migration destination.

The control unit observes the performance of the data transfer (S15). The performance to be observed is the data received at S14 with respect to the commands transmitted at S13. With this configuration, the control unit may evaluate the performance of the data transfer with respect to the set number of commands. The control unit holds a current value and a previous value of the performance in the storage unit (RAM 16 or HDD 17). The control unit replaces the previous value with the current value and stores the value of the observed performance as the current value. Thus, the control unit may evaluate the change in the performance in time series.

The control unit determines whether the migration of all of data to be migrated is completed (S16). When it is determined that the migration of some of data to be migrated is not completed, the process proceeds to S13. When it is determined that the migration of all of data to be migrated is completed, the control unit ends the data migration process.

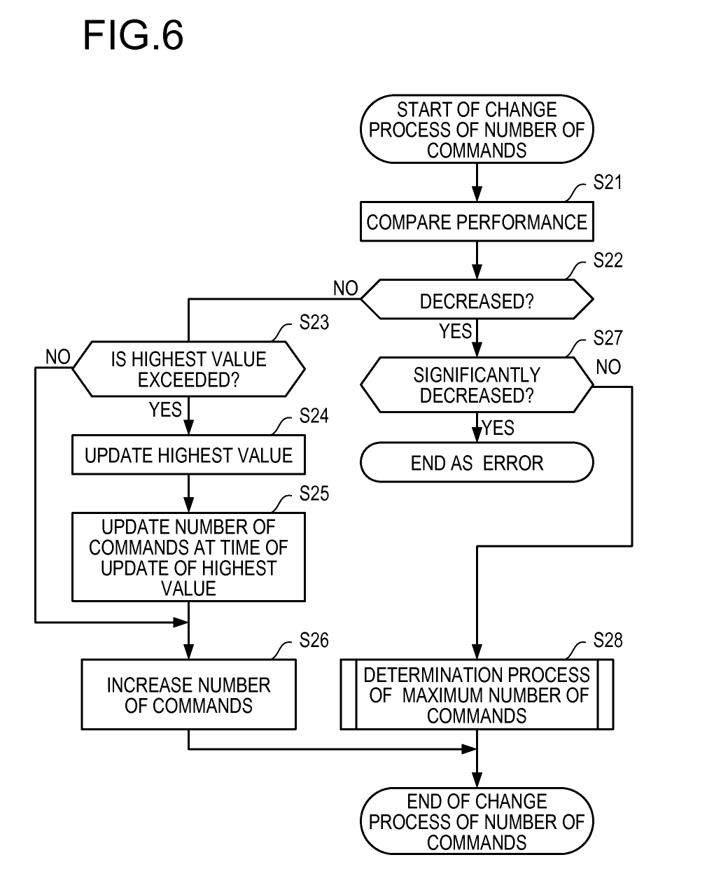

Next, descriptions will be made on a change process of the number of commands with reference to FIG. 6. FIG. 6 is a flowchart illustrating the change process of the number of commands according to the second embodiment. The change process of the number of commands is a process of changing the number of commands on the basis of the performance. The change process of the number of commands is performed by the control unit (processor 15) of the RAID device 13 of the data migration destination in parallel with the data migration process.

The control unit compares the current value of the performance with the previous value of the performance (S21). When the previous value with respect to the current value of the performance is not present, that is, for the performance which is observed for the first time, the comparison is performed by setting the previous value as “0”.

When the current value of the performance is decreased as compared to the previous value of the performance (YES in S22), the process proceeds to S27. When the current value of the performance is not decreased as compared to the previous value of the performance (NO in S22), the process proceeds to S23.

The control unit determines whether the current value of the performance exceeds the highest value of the performance (S23). The highest value of performance is the highest among the observed performance values. When it is determined that the current value of the performance exceeds the highest value of the performance, the process proceeds to S24. When it is determined that the current value of the performance does not exceed the highest value of the performance, the process proceeds to S26.

The control unit updates the highest value of the performance with the current value of the performance (S24). The control unit stores the highest value in the storage unit. The control unit updates the number of commands at the time of the update of the highest value (S25). The number of commands at the time of the update of the highest value corresponds to the number of commands at the time when the highest value is observed. For example, the number of commands at the time when the highest value is observed corresponds to the number of commands at the time when the highest value (maximum throughput) of the performance is observed.

The control unit increases the number of commands by a predetermined number (S26). The increment of the number of commands may be a preset number or a number (for example, 10% of the current number of commands) based on the current number of commands.

The control unit determines whether the current value of the performance is significantly decreased as compared to the previous value of the performance (S27). The determination as to whether the current value of the performance is significantly decreased as compared to the previous value of the performance may be performed by comparing a ratio of the previous value to the current value with a preset threshold value. The determination may be performed by comparing a difference between the previous value and the current value with a preset threshold value, in place of the comparison of the ratio of the previous value to the current value with a preset threshold value.

When it is determined that the current value of the performance is significantly decreased as compared to the previous value of the performance, the control unit ends the change process of the number of commands as an error. When it is determined that the current value of the performance is not significantly decreased as compared to the previous value of the performance, the process proceeds to S28.

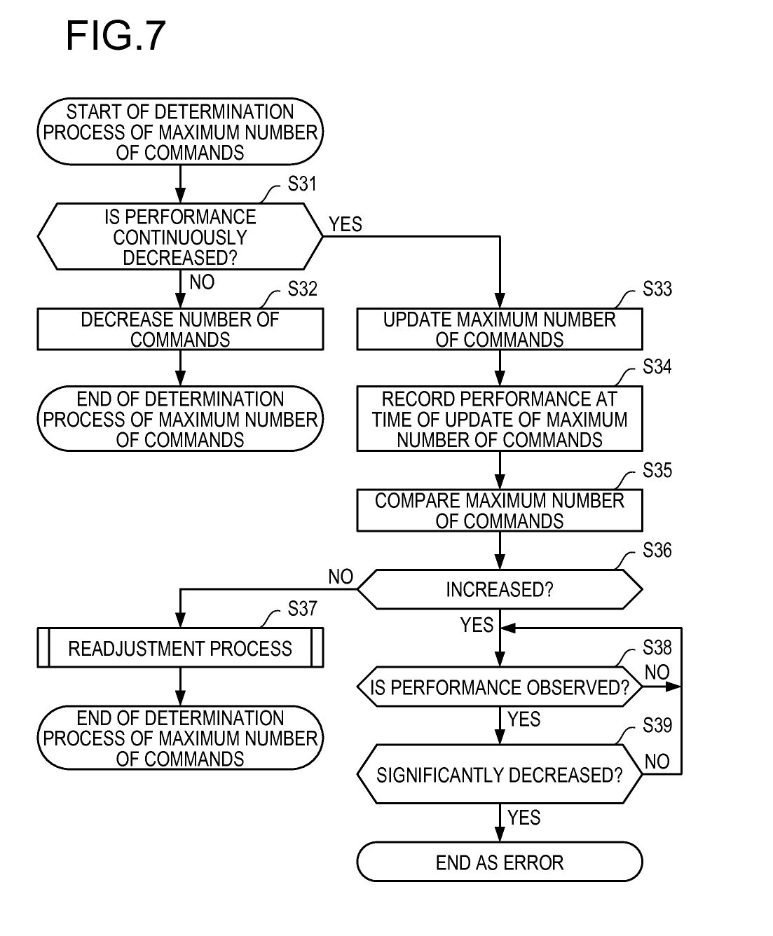

The control unit performs a determination process of the maximum number of commands and ends the change process of the number of commands (S28). Next, descriptions will be made on the determination process of the maximum number of commands with reference to FIG. 7. FIG. 7 is a flowchart illustrating the determination process of the maximum number of commands according to the second embodiment.

The determination process of the maximum number of commands is performed at S28 by the control unit (processor 15) of the RAID device 13 of the data migration destination. The control unit determines whether the performance is continuously decreased (S31). The continuous decrease in performance is a state where the performance is gradually decreased in an order of the one before previous value, the previous value, and the current value. The determination as to whether the performance is continuously decreased may be made by detecting a predetermined gradual decrease tendency. When it is determined that the performance is continuously decreased, the process proceeds to S33. When it is determined that the performance is not continuously decreased, the process proceeds to S32.

The control unit decreases the number of commands by a predetermined number (S32). The decrement of the number of commands may be a preset number or a number (for example, 10% of the current number of commands) based on the current number of commands for example. The control unit ends the determination process of the maximum number of commands after decreasing the number of commands.

The control unit updates the maximum number of commands with the current number of commands (S33). The maximum number of commands is regarded as the number of commands with which the data migration may be efficiently performed.

The control unit stores the performance observed at the time when the maximum number of commands is updated in the storage unit (S34). The control unit compares the current value of the maximum number of commands with the previous value (before the update performed at S33) of the maximum number of commands (S35).

When it is determined that the current value of the maximum number of commands is larger than the previous value of the maximum number of commands (YES in S36), the process proceeds to S38. When it is determined that the current value of the maximum number of commands is not larger than the previous value of the maximum number of commands (NO in S36), the process proceeds to S37.

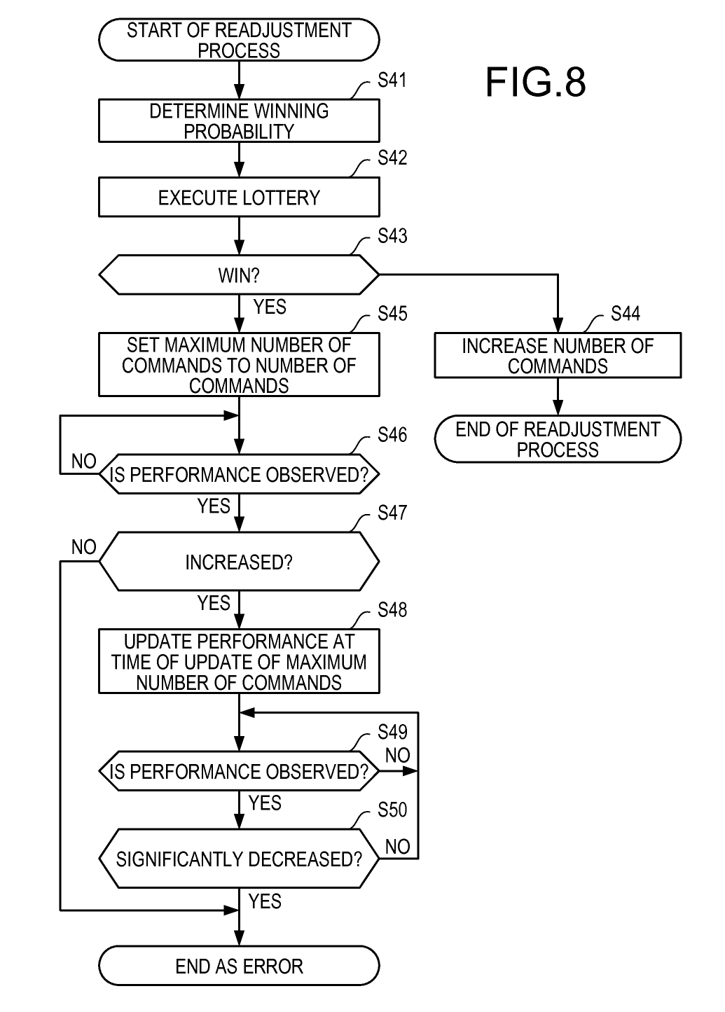

The control unit performs a readjustment process (S37). The control unit ends the determination process of the maximum number of commands after performing the readjustment process. The readjustment process is a process of increasing the number of commands by stochastically changing an increment ratio because the current maximum number of commands is small in efficiently performing the data migration. The readjustment process will be described later with reference to FIG. 8.

The control unit determines whether the performance after the update of the number of commands is observed (S38). When it is determined that the performance after the update of the number of commands is observed, the process proceeds to S39. When it is determined that the performance after the update of the number of commands is not observed, the control unit waits for the observation of the performance after the number of commands is updated. The current value of the performance is updated by observing the performance after the update of the number of commands.

The control unit determines whether the current value of the performance is significantly decreased as compared to the value of the performance at the time when the maximum number of commands is updated (S39). The determination as to whether the current value of the performance is significantly decreased as compared to the value (value to be compared) of the performance at the time when the maximum number of commands is updated may be performed by comparing a ratio of the value to be compared to the current value with a preset threshold value. The determination may be performed by comparing a difference between the value to be compared and the current value with a preset threshold value, in place of the comparison of the ratio of the value to be compared to the current value with a preset threshold value.

When it is determined that the current value of the performance is not significantly decreased as compared to the value of the performance at the time when the maximum number of commands is updated, the process proceeds to S38. When it is determined that the current value of the performance is significantly decreased compared to the value of the performance observed at the time when the maximum number of commands is updated, the control unit ends the determination process of the maximum number of commands as an error. That is, the control unit fixes the number of commands to the maximum number of commands until the determination process of the maximum number of commands is ended as an error.

Next, descriptions will be made on the readjustment process with reference to FIG. 8. FIG. 8 is a flowchart illustrating the readjustment process according to the second embodiment. The readjustment process is a process of increasing the number of commands by stochastically changing an increment ratio because the current maximum number of commands is small in efficiently performing the data migration. The readjustment process is performed in the determination process of the maximum number of commands at S37 by the control unit (processor 15) of the RAID device 13 of the data migration destination.

The control unit determines a winning probability in a lottery of whether the maximum number of commands is to be set to the number of commands (S41). The winning probability may be a fixed value which is set in advance or a value which varies depending on a control state.

The control unit performs the lottery to determine whether the maximum number of commands is to be set to the number of commands (S42). The control unit may perform the lottery using a random number. The control unit determines whether the lottery result is a win or not (S43). When it is determined that the lottery result is a win, the process proceeds to S45. When it is determined that the lottery result is not a win, the process proceeds to S44.

The control unit increases the number of commands by a predetermined number (S44). The increment of the number of commands may be a preset number or a number according to the current number of commands (for example, 10% of the current number of commands). The control unit ends the readjustment process after increasing the number of commands by the predetermined number.

The control unit sets the maximum number of commands to the number of commands (S45). Accordingly, the control unit may increase the number of commands to the maximum number of commands without gradually increasing the number of commands by spending a time.

The control unit determines whether the performance after the update of the number of commands is observed (S46). When it is determined that the performance after the update of the number of commands is observed, the process proceeds to S47. When it is determined that the performance after the update of the number of commands is not observed, the control unit waits for the observation of the performance after the update of the number of commands. The current value of the performance is updated by observing the performance after the update of the number of commands.

The control unit determines whether the current value of the performance is larger than the value of the performance at the time when the maximum number of commands is updated (S47). When it is determined that the current value of the performance is larger than the value of the performance at the time when the maximum number of commands is updated, the process proceeds to S48. When it is determined that the current value of the performance is not larger than the value of the performance at the time when the maximum number of commands is updated, the control unit regards the increase in the number of commands to the maximum number of commands as a failure and ends the readjustment process as an error.

Since the current value of the performance is larger than the value of the performance at the time when the maximum number of commands is updated, the control unit updates the performance at the time when the maximum number of commands is updated, which is written in the storage unit, with the current value (S48). Thereafter, in a case of being referenced as the value at the time when the maximum number of commands is updated, the current value becomes the value at the time when the maximum number of commands is updated.

The control unit determines whether the performance after the update of the number of commands is observed (S49). When it is determined that the performance after the update of the number of commands is observed, the process proceeds to S50. When it is determined that the performance after the update of the number of commands is not observed, the control unit waits for the observation of the performance after the update of the number of commands. The current value of the performance is updated by observing the performance after the update of the number of commands.

The control unit determines whether the current value of the performance is significantly decreased as compared to the value of the performance at the time when the maximum number of commands is updated (S50). When it is determined that the current value of the performance is not significantly decreased as compared to the value of the performance at the time when the maximum number of commands is updated, the process proceeds to S49. When it is determined that the current value of the performance is significantly decreased compared to the value of the performance observed at the time when the maximum number of commands is updated, the control unit ends the readjustment process as an error. That is, the control unit fixes the number of commands to the maximum number of commands which is set at S45 until the readjustment process is ended as an error.

Accordingly, the RAID device 13 of the data migration destination may return rapidly to a state of capable of issuing the highest number of commands. With the configuration as described above, the storage system 10 may improve an execution efficiency of the data migration.

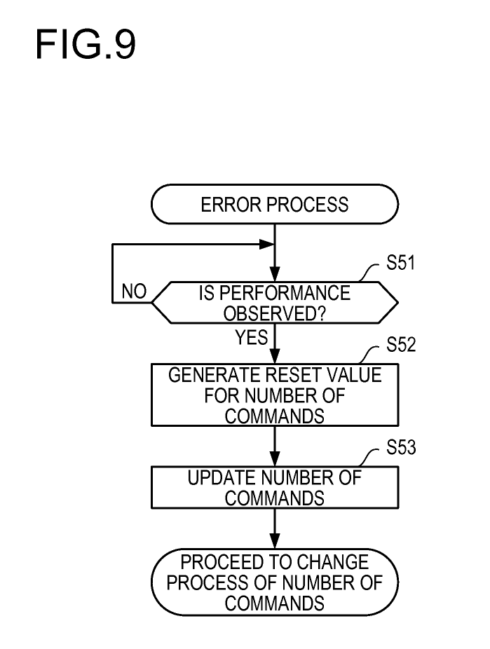

Next, descriptions will be made on the error process with reference to FIG. 9. FIG. 9 is a flowchart illustrating an error process according to the second embodiment. The error process is a process of determining a reset value for the number of commands when the performance is decreased and setting the determined reset value to the number of commands. The error process is a process performed by the control unit (processor 15) of the RAID device 13 of the data migration destination when the change process of the number of commands is ended as an error, the determination process of the maximum number of commands is ended as an error, or the readjustment process is ended as an error.

The control unit determines whether the performance after the update of the number of commands is observed (S51). When it is determined that the performance after the update of the number of commands is observed, the process proceeds to S52. When it is determined that the performance after the update of the number of commands is not observed, the control unit waits for the observation of the performance after the update of the number of commands. The current value of the performance is updated by observing the performance after the update of the number of commands.

The control unit generates the reset value for the number of commands according to the observed performance (S52). Here, descriptions will be made on the generation of the reset value. First, when it is assumed that the maximum value of the performance is Pₘₐₓ and the maximum value of the number of commands is kₘₐₓ, the coefficient “A” may be calculated by Equation (1).

A=Pₘₐₓ/kₘₐₓ (1)

Equation (2) may be obtained from Equation (1) by assuming that a relationship between the performance and the number of commands may be approximated in a form of a linear mathematical formula.

P=A×k (2)

When the performance observed at S51 is assumed as P₀, Equation (3) may be obtained from Equation (2) by estimating a reset value suitable for the current performance as kᵢₙₜ.

kᵢₙₜ=P₀/A (3)

The calculation formula of the kᵢₙₜ is illustrative and may be a formula which calculates (determines) the reset value by another calculation formula.

The control unit updates the number of commands with the calculated reset value (S53), and ends the error process. Upon completing the error process, the control unit performs the change process of the number of commands. Accordingly, the control unit (processor 15) of the RAID device 13 of the data migration destination may set a reset value having a good efficiency even when a decrease in performance exists. Accordingly, the storage system 10 may improve the execution efficiency of the data migration.

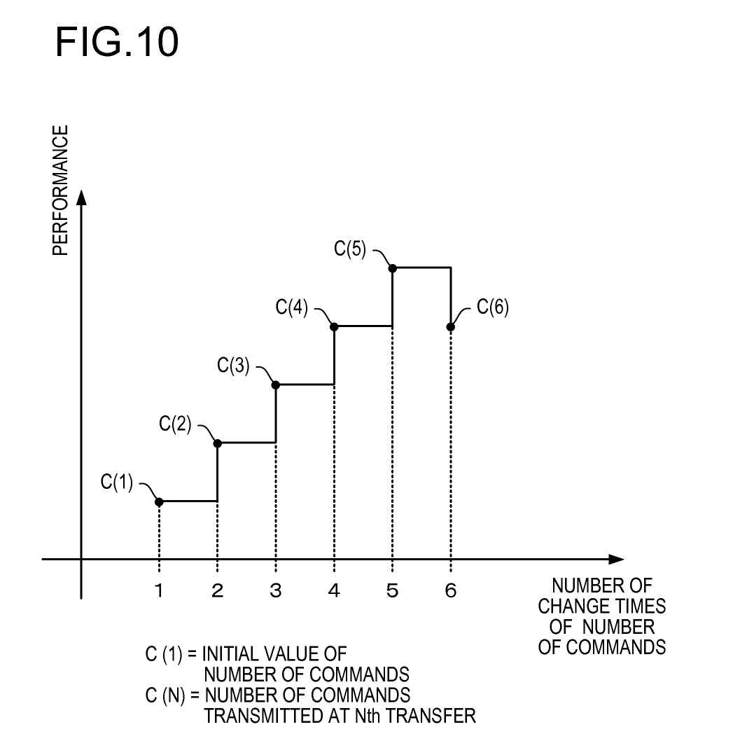

Next, descriptions will be made on a graph which illustrates a relationship between the performance and the number of change times of the number of commands according to the second embodiment with reference to FIG. 10. FIG. 10 is a graph illustrating a relationship between performance and the number of change times of the number of commands according to the second embodiment.

Descriptions will be made on the graph in which the performance is represented on the vertical axis and the number of change times of the number of commands is represented on the horizontal axis. In the vertical axis, the higher position indicates a higher performance value and the lower position indicates a lower performance value. The horizontal axis indicates that the number of change times of the number of commands increases along the rightward direction. C(N) in the graph indicates the number of commands transmitted at the Nth transfer by the RAID device 13 of the data migration destination. For example, the C(1) indicates the number of commands transmitted by the RAID device 13 of the data migration destination after the first change of the number of commands. C(2) indicates the number of commands transmitted by the RAID device 13 of the data migration destination after the second change of the number of commands.

The graph of FIG. 10 illustrates the performance for a case where the number of commands is discretely increased by a fixed number at the first to sixth change of the number of commands by the RAID device 13 of the data migration destination. In the graph, the performance increases at the number of commands from C(1) to C(5) and decreases at the number of commands C(6).

There are several factors causing the performance to decrease. The factors may include, for example, an increase of network traffic, an increase of processing load of the RAID device 13 of the data migration source, or a case where the number of commands exceeds processing capability of the RAID device 13 of the data migration source. Here, descriptions will be made on the case where the number of commands exceeds processing capability of the RAID device 13 of the data migration source as the factor of the decrease in performance according to the increase of the number of commands. In the RAID device 13 of the data migration source, since a load is applied to the processing of the large amount of received commands so that a staging process and the data transfer process of the data to be transmitted to the RAID device 13 of the data migration destination are delayed, the performance is decreased. In order to solve the decrease in performance described above, the RAID device 13 of the data migration destination needs to adjust the number of commands to be transmitted to the RAID device 13 of the data migration source.

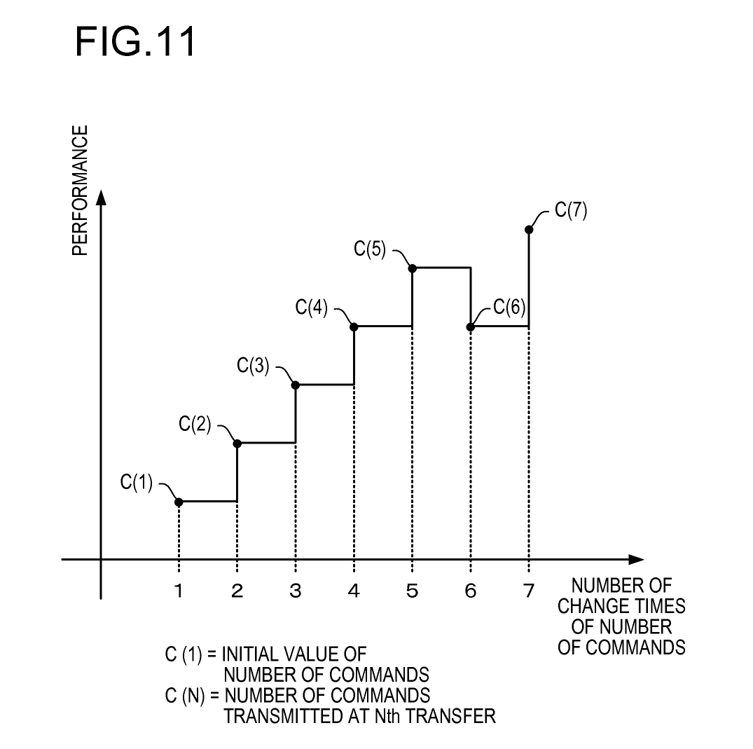

Next, descriptions will be made on a graph which illustrates another relationship between the performance and the number of change times of the number of commands according to the second embodiment with reference to FIG. 11. FIG. 11 is a graph illustrating another relationship between the performance and the number of change times of the number of commands according to the second embodiment.

Descriptions will be made on the graph of FIG. 11 in which the performance is represented on the vertical axis, and the number of change times of the number of commands is represented on the horizontal axis. The matters for the vertical axis, the horizontal axis, and C(N) are similar to those of FIG. 10. The graph of FIG. 11 is a continuation of FIG. 10 and illustrates the performance for a case where the number of commands is decreased at the seventh change of the number of commands.

In response to the measurement of the decrease in performance at the number of commands C(6), the RAID device 13 of the data migration destination decreases the number of commands to be transmitted and sets the number of commands C(7) as the number of commands to be transmitted. As a result, the performance at the number of commands C(7) is increased as compared to the performance of the number of commands C(6).

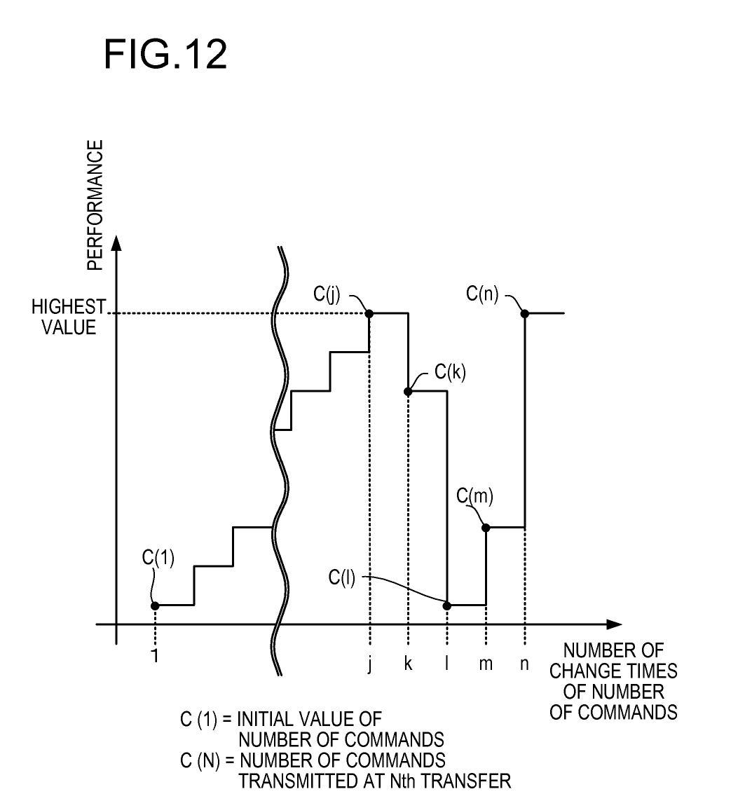

The RAID device 13 of the data migration destination transmits the number of commands capable of being handled by the RAID device 13 of the data migration source, thereby increasing the performance. Next, descriptions will be made on a graph which illustrates still another relationship between the performance and the number of change times of the number of commands according to the second embodiment with reference to FIG. 12. FIG. 12 is a graph illustrating still another relationship between the performance and the number of change times of the number of commands according to the second embodiment.

Descriptions will be made on the graph of FIG. 12 in which the performance is represented on the vertical axis and the number of change times of the number of commands is represented on the horizontal axis. The matters for the vertical axis, the horizontal axis, and C(N) are similar to those of FIG. 10. The number of commands C(j) was transmitted and the highest value in performance is shown at the jₜₕ change of the number of commands. Thereafter, the performance is decreased at the kₜₕ change of the number of commands. The RAID device 13 of the data migration destination decreases the number of commands C(l) to the same value as the number of commands C(1) in response to the decrease of performance at the kₜₕ change of the number of commands. Thereafter, the performance is increased at the mₜₕ change of the number of commands. The RAID device 13 of the data migration destination increases the number of commands C(n) to the same value as the number of commands C(j) in response to the increase of performance at the mₜₕ change of the number of commands. Thus, the performance is restored.

When the number of commands is not discretely increased or decreased by a fixed number but the number of commands that recorded the highest value or lowest value of the performance in the past is set, it is possible to cope with a case where the performance is temporarily decreased such that the original performance may be rapidly restored.

With the configuration as described above, the RAID device 13 may adjust the number of commands according to the performance so as to perform data migration according to the processing capability of the storage system.

The processing functions described above may be implemented by a computer. In this case, a program in which process contents of the functions to be equipped in the storage control device 3 and the RAID device 13 are described is provided. The program is executed by the computer such that the processing functions are implemented in the computer. The program having described therein the processing functions may be recorded in a computer-readable recording medium. The computer-readable recording medium may include, for example, a magnetic storage device, an optical disk, an opto-magnetic recording medium, and a semiconductor memory. The magnetic storage device may include, for example, an HDD, a flexible disk (FD), and a magnetic tape. The optical disk may include, for example, a DVD, a DVD-RAM, and a CD-ROM/RW. The opto-magnetic recording medium may include, for example, a magneto-optical disk (MO).

The program may be distributed in a portable recording medium such as, for example, a DVD or a CD-ROM in which the program is recorded. The program may be stored in a storage device of a server computer and transferred from the server computer to other computer via a network.

A computer which executes the program stores, for example, the program recorded in the portable recording medium or the program transferred from the server computer, in the storage device of its own. The computer reads the program from the storage device of its own and performs a process according to the program. The computer may read the program directly from the portable recording medium and perform the process according to the program. The computer may perform the process according to the program received sequentially each time when the program is transferred from the server computer connected via the network.

At least some of processing functions described above may be implemented with an electronic circuit such as a DSP, an ASIC or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device, comprising:
a memory device configured to
store a transfer amount of data to be transmitted to a first storage device; and
a processor configured to
perform, on basis of the transfer amount, a transfer request of requesting a second storage device to perform data transfer of transmitting data to the first storage device,
observe a throughput of the data transfer, and
update the transfer amount on basis of the throughput.

2. The storage control device according to claim 1, wherein
the transfer amount is a first number, the first number being a number of commands to be transmitted to the first storage device, and
the processor is configured to
transmit first commands to perform the transfer request, a number of the first commands being the first number.

3. The storage control device according to claim 2, wherein
the processor is configured to
perform the transfer request repeatedly,
observe the throughput of the data transfer corresponding to each transfer request, and
update the first number stored in the memory device on basis of the throughput of the data transfer corresponding to each transfer request.

4. The storage control device according to claim 3, wherein
the processor is configured to
store a second number as a maximum number in the memory device, a number of commands transmitted to perform a first transfer request being the second number, a first throughput of a first data transfer corresponding to the first transfer request being observed to be a maximum, and
update, upon updating the first number stored in the memory device to be decreased, the first number stored in the memory device with the maximum number when a predetermined condition is satisfied.

5. The storage control device according to claim 3, wherein
the processor is configured to
store a second number as a maximum number in the memory device, a number of commands transmitted to perform a first transfer request being the second number, a first throughput of a first data transfer corresponding to the first transfer request being observed to be a maximum,
determine, upon updating the first number stored in the memory device to be decreased, a reset value for the first number on basis of the first throughput and the maximum number stored in the memory device, and
update the first number stored in the memory device with the reset value.

6. A computer-readable recording medium having stored therein a program that causes a computer to execute a process, the process comprising:
storing a transfer amount of data to be transmitted to a first storage device;
performing, on basis of the transfer amount, a transfer request of requesting a second storage device to perform data transfer of transmitting data to the first storage device;
observing a throughput of the data transfer; and
updating the transfer amount on basis of the throughput.
